(19) United States
(12) Patent Application Publication
(10) Pub. No.: US 2013/0016825 A1
(43) Pub. Date: Jan. 17, 2013

(54) METHOD AND APPRATUS FOR ADVANCED ENCRYPTION STANDARD

(71) Applicants: Dvor Efrat, Rishon Le-Zion (IL); Eran Amir, Givat Ada (IL)

(72) Inventors: Dvor Efrat, Rishon Le-Zion (IL); Eran Amir, Givat Ada (IL)

(73) Assignee: DSP Group Ltd., Herzeliya (IL)

(21) Appl. No.: 13/180,567

(22) Filed: Jul. 12, 2011

(51) Int. Cl. H04L 9/28

(52) U.S. Cl. 380/28

(57) ABSTRACT

A method for AES comprising performing AES on a provided state of data elements at the original locations of the data elements in the provided state without moving the data elements in the state, and an apparatus for performing the same.

### BACKGROUND

The present disclosure generally relates to encryption of data and more specifically to advanced encryption standard (AES).

The advanced encryption standard (AES) was approved by the US governments, as reported, for example, Federal Information Processing Standards Publication 197, Nov. 26, 2001 (http://csrc.nist.gov/publications/fips/fips197/fips-197.pdf).

Several implementations of AES have been published. For example, U.S. Pat. No. 7,809,132 reports an AES encryption processor for reducing hardware with improved throughput, or US Application No. 2003/0133568 that reports a programmable data encryption engine for performing the cipher function of an AES algorithm.

### SUMMARY

For brevity and clarity, in the present disclosure ‘AES’ refers to advanced encryption standard.

One exemplary embodiment of the disclosed subject matter is a method for AES, comprising performing AES on a provided state array of data elements at the original locations of the data elements in the provided state array.

Another exemplary embodiment of the disclosed subject matter is an apparatus for AES, comprising: a circuitry for accessing a state array of data elements, a structure of indexes to the state array for accessing data elements, and a mechanism for activating indexes to access data elements as virtually shifting rows and to access columns of the virtually shifted rows.

It is noted that that the present disclosure describes AES encryption, without precluding AES decryption since decryption of AES is the reverse of encryption.

In the context of the present disclosure, without limiting, a state array implies a an array as a part of a message of data to be encrypted, wherein a standard state array implies a part of a message ordered according to the data in the respective part of the message. It is noted that the array organization is a conceptual organization and may be implemented in various manners.

In the context of the present disclosure, without limiting, data elements imply data in a state array, wherein original location of the data elements imply the location of the data elements as provided for encryption.

In the context of the present disclosure, without limiting, maintaining the original locations of the data elements implies that the data location or corresponding derivatives thereof do not move from the original locations of the data elements in the array during AES, wherein a derivative of data elements is a modification of the contents of a data element.

In the context of the present disclosure, without limiting, maintaining the original locations of data elements implies that the data elements do not change the locations thereof in the provided state array.

In the context of the present disclosure, without limiting, exclusive of intermediate storing implies without storing the state array or a derivative thereof in addition to the provided state array, wherein a derivate of a state array implies a provided state array with at least one modified data element.

In the context of the present disclosure, without limiting, accessing locations of data elements according to indexes implies accessing by variable indexes or pointers indicating and/or selecting the locations of the data elements.

In the context of the present disclosure, without limiting, virtually shifting rows by the indexes implies that the rows are accessed by the indexes as if shifted while the original location of the data elements, or derivatives thereof, are maintained.

In the context of the present disclosure, without limiting, accessing as virtual columns by the indexes implies that columns pertaining to a standard state array are accessed by the indexes at locations which are not necessarily along a column in a provided array; and particularly, without limiting, accessing data elements of a column of a standard state array at locations in a virtually shifted state array which are not along a column in the virtually shifted state array.

It should be recognized that in the context of AES, and in context of the present disclosure unless otherwise specified, a shift operation implies, in fact, a rotate operation where the shifted data elements are wrapped-around.

For brevity and clarity, in the present disclosure referring to a state implies a state array as a rectangular array of R rows and C columns with or storing R×C data elements.

### BRIEF DESCRIPTION OF THE DRAWINGS

Some non-limiting exemplary embodiments or features of the disclosed subject matter are illustrated in the following drawings.

Identical or duplicate or equivalent or similar structures, elements, or parts that appear in one or more drawings are generally labeled with the same reference numeral, optionally with an additional letter or letters to distinguish between similar objects or variants of objects, and may not be repeatedly labeled and/or described.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

FIG. 1A schematically illustrates a state to be shifted and the state after being shifted once and twice;

FIG. 1B schematically illustrates accessing a column in a virtually shifted state, according to exemplary embodiments of the disclosed subject matter;

FIG. 1C schematically illustrates accessing subsequent columns in a virtually shifted state, according to exemplary embodiments of the disclosed subject matter;

FIG. 2 schematically illustrates accessing a virtually shifted column in a pre-shifted state, according to exemplary embodiments of the disclosed subject matter;

FIG. 3A schematically illustrates a block diagram of a part of an apparatus for AES, according to exemplary embodiments of the disclosed subject matter;

FIG. 3B schematically illustrates a block diagram of an apparatus for AES, according to exemplary embodiments of the disclosed subject matter; and

FIG. 4 illustrates an outline of operations for AES, according to exemplary embodiments of the disclosed subject matter.

### DETAILED DESCRIPTION

One technical problem dealt with by the disclosed subject matter is improving AES implementation in terms of amount of processing in general and, in case of hardware implementation, in terms of simplified circuitries.

One technical solution a circuitry and/or a processor coupled with a medium storing of instruction for encryption and/or decryption of a message by AES without moving data of the message's part or using intermediate storage, by employing pointers to access and process items of the message in their original location, namely, ‘in place computation’. In some embodiments of the present disclosure, the message part is provided in an organization according to a prediction of the message's part organization as though AES was performed on the message's part so that the result is ready without any shifts of data.

A potential technical effect of the present disclosure is a faster and more economic implementation in terms of storage and when a hardware circuitry is used then a potential technical effect is a less complicated and smaller footprint of the circuitry with less power consumption, relative to other implementations.

A general non-limiting overview of practicing the present disclosure is presented below. The overview outlines exemplary practice of embodiments of the present disclosure, providing a constructive basis for variant and/or alternative and/or divergent embodiments, some of which are subsequently described.

According to publication 197 cited above, the AES encryption is illustrated schematically as the following Cipher procedure:

```
Cipher(byte in[4*Nb], byte out[4*Nb], word w[Nb*(Nr+1)])
begin
  byte state[4,Nb]
  state = in
  AddRoundKey(state, w[0, Nb−1])
  for round = 1 step 1 to Nr−1
    SubBytes(state)
    ShiftRows(state)
    MixColumns(state)
    AddRoundKey(state, w[round*Nb, (round+1)*Nb−1])
  end for
  SubBytes(state)
  ShiftRows(state)
  AddRoundKey(state, w[Nr*Nb, (Nr+1)*Nb−1])
  out = state
end;
```

Where:

A message to be encrypted is divided into one or more parts as states or state array, where a state or state array may be pictured as a rectangular array of bytes as data elements.

Nb—is the number of columns comprising the state. Presently Nb=4.

Nr—is the number of rounds or cycles of AES for a state, where Nr=10, 12, or 14.

AddRoundKey( )—is a transformation in which a round key is added to the state using a XOR operation.

MixColumns( )—is a transformation that takes all of the columns of the state and mixes their data, independently of one another, to produce new columns.

In the following description and accompanying drawings, without limiting, a state is referred to as an array of four rows and four columns, the rows and columns numbered successively from 0 to 3.

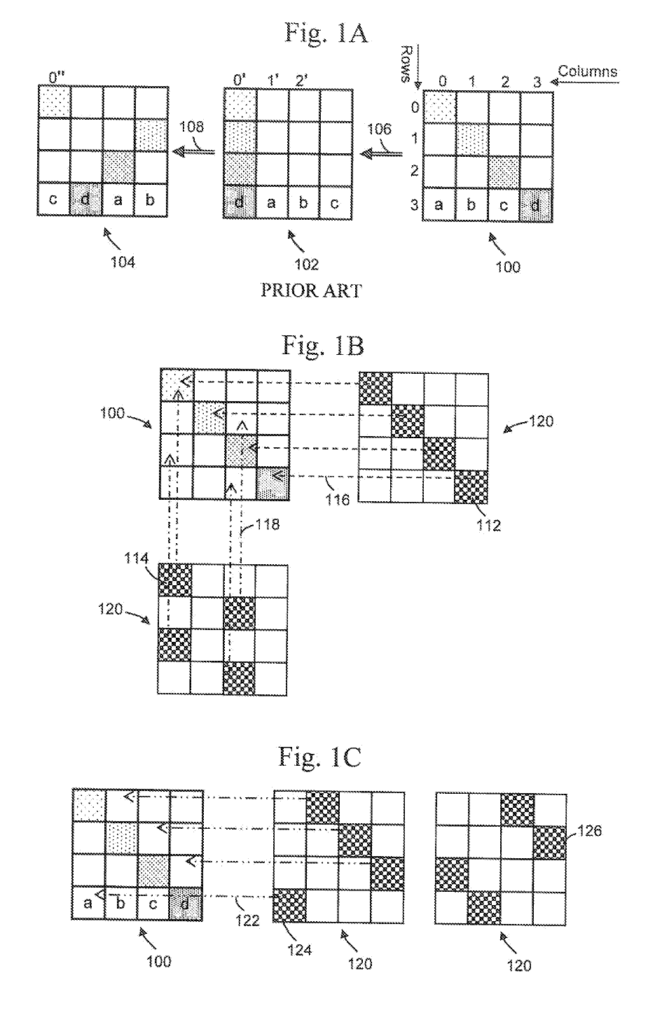

FIG. 1A schematically illustrates a state 100 with 16 data elements, with indicated rows from row 0 to row 3 and columns from column 0 to columns 3. A state 102 illustrates state 100 after being shifted once as indicated by arrow 106, and state 104 illustrates state 102 after being shifted once as indicated by arrow 108 as equivalent to shifting state 100 twice.

It is noted that according to AES procedure row 0 is not shifted, that is a shift of zero steps whereas row 1 is left shifted by one step, row 2 is left shifted by two steps and row 3 is shifted by three steps. Shifted state 102 is indicated by shadings of data elements corresponding to state 100. For clarity, row 3 is marked with letters to indicate the shift where the rest of the data elements are not marked.

According to embodiments of the present disclosure, in order to access a column in a state after being shifted, it is not necessary to actually shift the rows. Rather, the data elements of the state are kept in the original location thereof while the data elements are accessed as if the data elements were actually shifted. In other words, the state is ‘virtually’ shifted rather than actually shifted. The data elements, as if shifted or as virtually shifted, are accessed according to indexes or pointers that indicate either directly or indirectly, to the virtually shifted data elements.

FIG. 18 schematically illustrates accessing a column in a virtually shifted state, according to exemplary embodiments of the disclosed subject matter.

In order to access the left-most column of state 100 as virtually shifted once, corresponding to column 0 of state 102 as state 100 after actual shift where column 0 of state 102 is denoted as 0′, a pointers-set 120 with active points 112 is used to access the data elements of state 100 as indicated by dashed arrows 114.

Likewise, in order to access the left-most column of state 100 as virtually shifted twice, corresponding to column 0 of state 104 as state 100 after actual shift twice where column 0 is denoted as 0″, pointers-set 120 with active pointes 114 is used to access the data elements of state 100 as indicated by dash-dot arrows 118.

In some embodiments, pointers-set 120 is a set of sixteen pointers, each used to access a data element in a state while four out of the sixteen pointers are active pointers accessing corresponding data elements of a state. Optionally or alternatively, pointers-set 120 comprises one or less than sixteen pointers where the pointer or pointers are modified to access the data element in a state. It is noted that a pointer may denote an index such as index of an array where an index may be structured as a pair of values or any other construct, to access a data element in a state, such as one value for a row and one value for a column.

In some embodiments, pointers-set 120 is arranged, at least conceptually, as 16 pointers in a similar structure as a state, each pointer for accessing a corresponding data element in a state.

An active pointer or active index in pointers-set 120 is a pointer currently assigned to access a data element, where an inactive pointer, at least temporarily, is non-operative. Having an organization corresponding to a state, the pointers in pointers-set 120 may comprise a flag or mark to denote which pointer is active and which one is inactive. For example, active pointers may be denoted by a ‘true’ or 1 value and inactive may be denoted by a ‘false’ or 0 value. Thus, in some embodiments, pointers-set 120 is arranged as a 16 bit structure, where a bit of 1 denotes an active pointer and a bit of 0 denotes an inactive pointer, or using any other logic scheme.

It is noted that pointers-set 120 may be arranged in an organization that reflects, such as by logic and/or other data structure, the correspondence to the organization of a state. It is noted, again, that a pointer may be referred to as an index, such that pointers-set 120 refers to a set of indexes.

In the present disclosure, without limiting and unless otherwise specified, it is assumed that pointers-set 120 is arranged as, or reflects, the organization of a state.

FIG. 1C schematically illustrates accessing subsequent columns in a virtually shifted state, according to exemplary embodiments of the disclosed subject matter.

Similarly to FIG. 1B and respective description, in order to access the second from left column of state 100 as virtually shifted once, corresponding to column 1 of state 102 as state 100 after actual shift where column 1 of state 102 is denoted as, 1′, pointers-set 120 with active pointes 124 is used to access the data elements of state 100 as indicated by dash-dot-dot arrows 122.

Likewise, in order to access the third from left column of state 100 as virtually shifted once, corresponding to column 2 of state 102 as state 100 after actual shift where column 2 of state 102 is denoted as 2′, pointers-set 120 with active pointes 126 is used to access the data elements of state 100 (arrows not shown for clarity).

It is noted that for accessing columns in a virtually shifted state the active pointes of pointers-set 120 are shifted according to the column. For example, taking active pointers 112 of pointers-set 120 as zero-shifted, in order to get obtain pointers 124 for the second column, or column 1, corresponding to column 1′ of actually shifted state 102, pointers 112 are shifted right one step. Likewise, for example, taking active pointers 112 of pointers-set 120 as zero-shifted, in order to get obtain pointers 126 for the second column, or column 2, corresponding to column 2′ of actually shifted state 102, pointers 112 are shifted right two steps.

Thus, in order to obtain pointers for successive columns in a virtually shifted state, the active pointers of pointers-set 120 are successively shifted, or rotated, either left or right respective to the columns succession.

As a generalization, in some embodiments, in order to obtain active pointers for column n, where n=0 . . . , base active pointers, such as pointers 112, are shifted n times.

It is emphasized that virtually shifting a state, corresponding to the ‘ShiftRows(state)’ illustrated above, is carried out without moving the data element in a state.

Accessing data elements in columns of a virtually shifted may be used for the mix-columns phase of AES, corresponding to the ‘MixColumns(state)’ illustrated above, either before or after the data elements substitution, corresponding to the ‘SubBytes(state)’ illustrated above.

It is emphasized again that during or after operations such as the mix-columns phase of AES or the data elements substitution, the date elements of a state or derivatives thereof, do not change the locations thereof in the state, nor no auxiliary or intermediate storage of the state is required. A derivate of a data element of a state is, for example, a data element after an operation of AES such as mix-columns or substitution. Without limiting, a state with data elements as derivative of the original data elements is considered as a state as well.

In some embodiments, after the operations of AES are done, the virtually shifted states is used to form an organization of an actually shifted state. For example, the pointers in pointers-set 120 are used to access the data elements of the virtually shifted state and store them as output of the AES in an organization of actually shifted rows.

In some embodiments, the state is provided in an organization where the rows are actually pre-shifted. The shifts are predicted according to the expected number of rounds, or cycles, of the AES as based on the key length. For example, as the message for encryption is divided into one or more states, a state is formed as if the rows are shifted accordingly as expected or predicted by the number of rounds. It is noted again that a state formed directly form a message part without pre-shifting or other alterations is referred to as a standard state.

Having a state in a pre-shifted organization, the data elements of the states may be accessed by the pointers, such as in pointers-set 120, to perform operations of AES in the place of the data elements (‘in situ’). For example, the rows are virtually shifted taking into account that the state is pre-shifted so that the rows are virtually shifted, as described above, by accessing data elements locations in the state, and that without actually shifting rows of data elements of the state. The rows are virtually shifted to access data elements in a column as if the standard state was shifted, and likewise data elements in the pre-shifted state are accessed for elements as if in a standard state.

Operations of AES such as substitution of data elements or columns mixing are performed by accessing the required data elements and performing the operation. The results of the operations are stored back in the respective locations of the pre-shifted state so that when the AES operation is done, the state is ready as an output of AES without moving the data elements in the state and/or without requiring a another storage for storing the state.

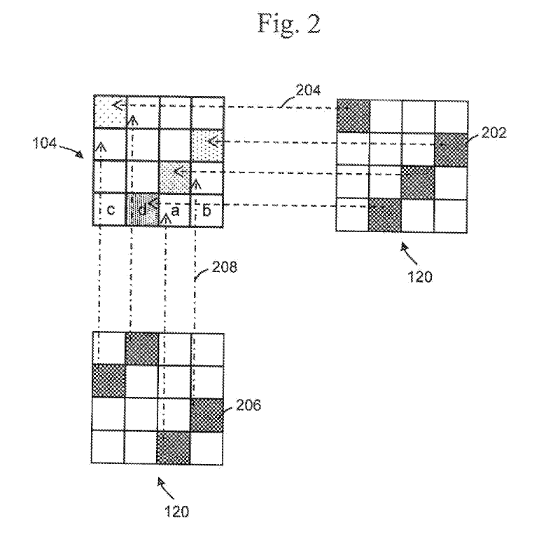

FIG. 2 schematically illustrates accessing a virtually shifted column in a pre-shifted state, according to exemplary embodiments of the disclosed subject matter.

Referring also to FIG. 1A and, for simplicity without limiting, state 104 that is actually shifted twice is referred to represent a pre-shifted state.

For accessing a left-most column in the standard state as if after one shift, corresponding to column 0 in once shifted standard state, denoted as 0′, the data elements in the pre-shifted state 104 are accessed according to active pointers 202 in pointers-set 120 as indicated by dashed arrows 204.

Likewise, for accessing a second to left-most column in the standard state as if after one shift, corresponding to column 1 in once shifted standard state, denoted as 1′, the data elements in the pre-shifted state 104 are accessed according to active pointers 206 in pointers-set 120 as indicated by dash-dot arrows 208.

Since decryption of encoded message is a reverse of AES encryption, the same methods as described above may be used to decode a message. For example, the encrypted message is divided to one or more state arrays, and virtual shifting and other operations are performed on the state arrays in-place, neither moving the data elements of the state array nor without using an additional storage for the state array, providing eventually a decrypted state array.

It is noted that data elements in a virtually shifted state or a pre-shifted state that correspond to a column of a standard state, or of a shifted standard state, are referred to as a virtual column, whereas the data elements are not actually along a column in the pre-shifted state or the virtually shifted state. For example, as illustrated by arrows 122 in FIG. 1B or arrows 204 and arrows 208 in FIG. 1C.

In some embodiments, the AES on a state is preformed by software as a program stored in a storage device or embedded in a circuitry such as integrated circuit, where the program is readable and executable by a processor such as general purpose computer of a DSP (Digital Signal Processor). Optionally, the AES operations are assisted by an additional circuitry such as additional logic and/or input/output devices or circuitries.

In some embodiments of the present disclosure, AES on a state is performed by hardware circuitry, optionally coupled or linked to a processor operating under a program stored or embedded in a device.

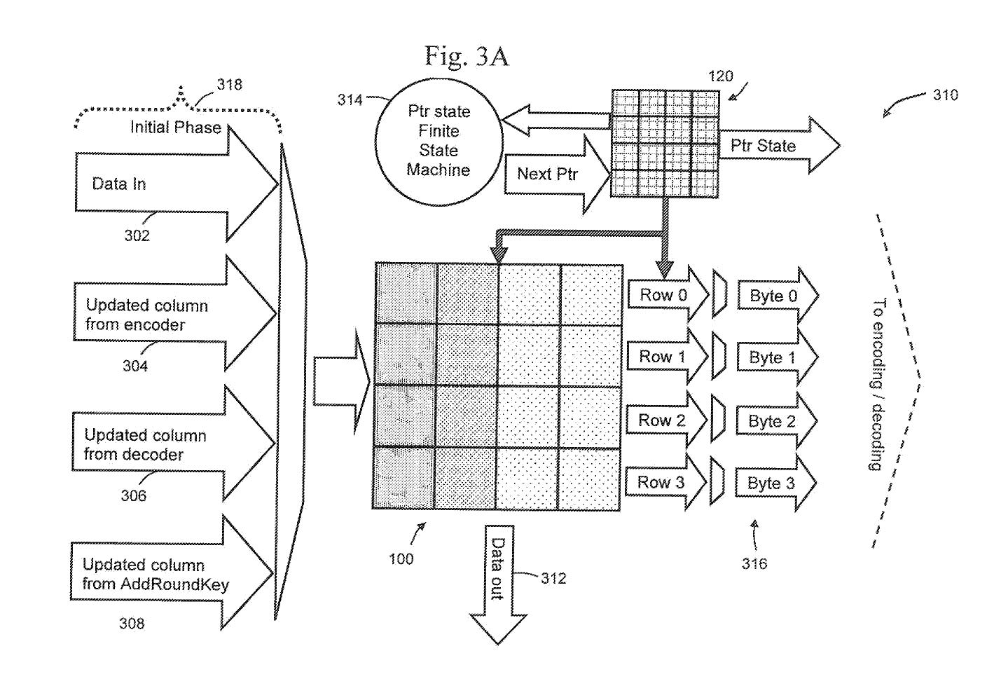

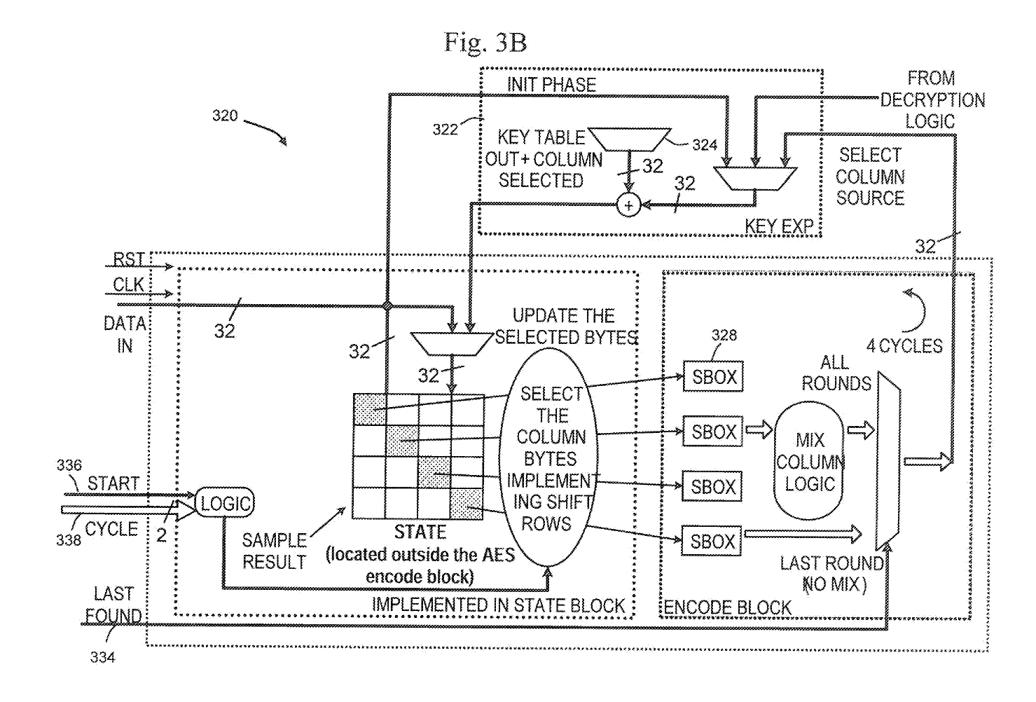

FIG. 3A schematically illustrates a block diagram 310 of a part of an apparatus for AES, according to exemplary embodiments of the disclosed subject matter. Block diagram 310 comprises a state 100 and a pointers-set 120 organized, at least conceptually, according to the organization of state 100.

Data for data elements for state 100 and controls for accessing the data elements in state 100 are provided as a group illustrated under a dotted bracket 318. A data path 302 provides data for state 100, where control path 304 and control path 306 and control path 308, from address encoder, address decoder and from round-key, respectively (not shown), provide addressing control for state 100. The data and control are provided for each round or cycle of AES.

On the other hand, under control of pointer state a finite state machine 314 as, for example, a logic circuit, pointers as one-bit indexes or flags are set to access rows in state 100 and to access in each row the data elements as required such as, without limiting, for virtual shift or for columns mixing or for data element substitution.

For example, given a state 100 ready for columns mixing, active indexes in pointers-set 120 are set to access the left-most column in state 100, indicated in a darker shade relative to the rest of the columns of state 100. The data elements of the left-most column are accessed, and provided for the mixing of the data elements, indicated by arrow 316, where the results of the mixing are stored back in the left-most column of state 100. Subsequently, the active indexes of pointers-set 120 are adjusted, such as by shifting or virtual shifting of pointers-set 120, and the next column of state 100, indicated as a medium shade relative to the rest of the columns of state 100, is accessed for column mixing, an so forth. Once operations of AES on state 100 are over, the data elements of state 100 are provided as output of AES for the state, as indicated by data path 320.

In some embodiments, using indexes as one-bit allows to use the indexes as clock-gate or chip-enable to access data elements in state 100, thereby saving additional circuitry and power consumption for indexing.

It is noted, again, that data elements in state 100 do not move from the locations thereof as provided but, rather, are read and written back to the locations thereof as provided.

Corresponding to FIG. 3A, FIG. 3B schematically illustrates a block diagram 320 of an apparatus for AES, according to exemplary embodiments of the disclosed subject matter.

Block diagram 320 accesses a state 100 either at an external storage outside block diagram 320 or, alternatively, block diagram 320 stores state array 100. Initial data elements to state 100 for AES cycles are provided via data path 302.

A key circuitry 322 provides the key expansion for XORing the data elements of state 100, and a column select circuitry 324 provides initial active indexes for selecting data elements for operations such as virtual rows shift or virtual column access.

The output of key circuitry 322 and column select circuitry 324 are combined and used for key expansion of state 100 and for selection of data elements of state 100. According to the active indexes, data elements of state 100 are virtually shifted by shift circuitry 326 and a substitution circuitry 328, such as by lookup tables, substitutes data elements of state 100.

A mix-columns circuitry 332 performs a mix columns operation and, subsequently, column select circuitry 324 updates the active indexes for the next cycle.

A start signal 336 initiates the AES operations for state 100, where cycle signal 338 keeps track of the cycles. In the last cycle, as indicated by signal 334, the mix column operation is skipped as specified by AES.

The data elements of state 100 are accessed by single-bit indexes such that the active indexes have logical values that enable access to the required data elements while the rest of the indexes have reverse values as inactive indexes.

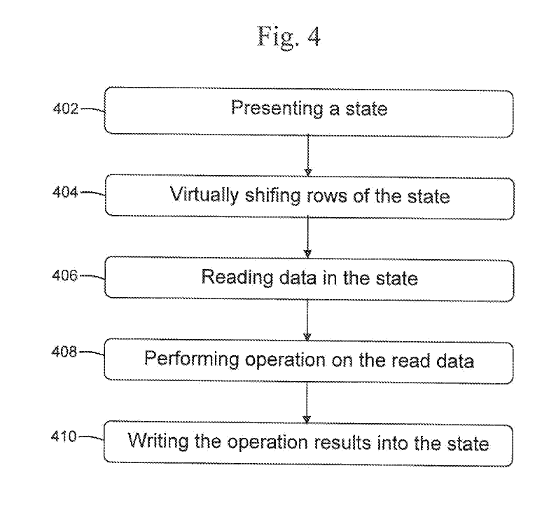

FIG. 4 illustrates an outline of operations for AES, according to exemplary embodiments of the disclosed subject matter.

At 402 a state is presented or provided. For example, as a message for encryption is provided, a part of the message is arranged in a rectangular array as a state of AES.

At 404 the shift-rows operation is performed by virtually shifting rows of the state without moving any data of the state. For example, data as if shifted are accessed using pointers or indexes to the corresponding data elements as if the elements were shifted.

In some embodiments, the state is organized according to a prediction of the locations of data elements in a standard state as though AES was performed, at least as rows shifting, on the standard state array. Thus, after AES was performed on the state by virtual rows shifting, the state is arranged as the rows were actually shifted and the state is ready as an output of AES.

It is noted again that as used herein, without limiting, a standard state implies a part of a message ordered according to the data in the respective part of the message.

At 406 data of the state is read, such as by picking or reading values that, for example, correspond to a column in an actually shifted state for column mixing, or picking values for substitution.

At 408 the read value are used as data for performing AES operations to obtain results of AES such as columns mixing or data substitution.

At 410 the results are written back to the corresponding locations in the array from which the values were read, thus maintaining the locations of the values or derivates thereof in the state, wherein a derivate of a value is a value after an AES operation.

It is noted that, when practical, the order of the operations of FIG. 4 may be modified. For example, value substitution may be performed before rows shifting.

In some embodiments, the method and apparatus used for encryption by AES are used for decryption by AES, since a decryption by AES comprises a reverse process of encryption by AES.

It is noted that beyond or apart of AES, the methods and/or apparatus as described above or as a variation thereof may be used for performing operations on a data structures without moving elements of the data structure and/or modifying the organization of the data structure.

There is thus provided in the present disclosure a method for AES, comprising performing AES on a provided state array of data elements at the original locations of the data elements in the provided state array, where in some embodiments, the provided state array is organized according to a prediction of the locations of data elements in a standard state array as though AES was performed on the standard state array.

In some embodiments, performing AES on the provided state array of the data elements comprises maintaining the original locations of the data elements or corresponding derivatives thereof in the provided state array, where, in some embodiments, performing AES on the provided state array is carried out exclusive of intermediate storing of the provided state array.

In some embodiments, performing AES on the provided state array of the data elements comprises accessing the original locations of the data elements in the provided state array according to indexes.

In some embodiments, rows of the provided state array are virtually shifted by the indexes, thereby maintaining the original locations of the data elements in the provided state array, where, in some embodiments, elements or derivative thereof in the provided state array are accessed as by the indexes as virtual columns.

In some embodiments, the method for AES is either for encryption by AES or for decryption by AES.

There is thus provided according the present disclosure an apparatus for AES, comprising a circuitry for accessing a state array of data elements, a structure of indexes to the state array for accessing data elements, and a mechanism for activating indexes to access data elements as virtually shifting rows and to access columns of the virtually shifted rows.

In some embodiments, the indexes are used as signals to enable access to data elements corresponding to the indexes, where, in some embodiments, the signals are at least one of chip enable or clock gate.

In some embodiments, the apparatus for AES is either for encryption by AES or for decryption by AES.

The terms ‘processor’ or ‘computer’, or system thereof, are used herein as ordinary context of the art, such as a general purpose processor or micro-processor, RISC processor, or DSP, possibly comprising additional elements such as memory or communication ports. Optionally or additionally, the terms ‘processor’ or ‘computer’ or derivatives thereof denote an apparatus that is capable of carrying out a provided or an incorporated program and/or is capable to controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as memory.

The terms ‘software’, ‘program’, ‘software procedure’ or ‘procedure’ or ‘software code’ or ‘code’ may be used interchangeably according to the context thereof, and denote one or more instructions or directives or circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry.

The processor and program may constitute the same apparatus, at least partially, such as an array of electronic gates, such as FPGA or ASIC, designed to perform a programmed sequence of operations, optionally comprising or linked with a processor or other circuitry.

In case electrical or electronic equipment is disclosed it is assumed that an appropriate power supply is used for the operation thereof.

The processor and/or program stored in or on a device constitute an article of manufacture.

The flowchart and block diagrams illustrate an architecture, a functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated operations may occur in deferent order or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The terminology used herein is for the purpose of describing particular embodiments only and is not intended to be limiting of the disclosed subject matter. While certain embodiments of the disclosed subject matter have been illustrated and described, it will be clear that the invention is not limited to the embodiments described herein. Numerous modifications, changes, variations, substitutions and equivalents are not precluded.

1. A method for AES, comprising:
performing AES on a provided state array of data elements at the original locations of the data elements in the provided state array.

2. The method for AES according to claim 1, wherein the provided state array is organized according to a prediction of the locations of data elements in a standard state array as though AES was performed on the standard state array.

3. The method for AES according to claim 1, wherein performing AES on the provided state array of the data elements comprises maintaining the original locations of the data elements or corresponding derivatives thereof in the provided state array.

4. The method for AES according to claim 1, wherein performing AES on the provided state array is carried out exclusive of intermediate storing of the provided state array.

5. The method for AES according to claim 1, wherein performing AES on the provided state array of the data elements comprises accessing the original locations of the data elements in the provided state array according to indexes.

6. The method for AES according to claim 5, wherein rows of the provided state array are virtually shifted by the indexes, thereby maintaining the original locations of the data elements in the provided state array.

7. The method for AES according to claim 5, wherein elements or derivative thereof in the provided state array are accessed by the indexes as virtual columns.

8. The method for AES according to claim 1, wherein AES comprises either one of encryption by AES or decryption by AES.

9. An apparatus for AES, comprising:
a circuitry for accessing a state array of data elements;
a structure of indexes to the state array for accessing data elements; and
a mechanism for activating indexes to access data elements as virtually shifting rows and to access columns of the virtually shifted rows.

10. The apparatus for AES according to claim 9, wherein the indexes are used as signals to enable access to data elements corresponding to the indexes.

11. The apparatus for AES according to claim 10, wherein the signals are at least one of chip enable or clock gate.

12. The apparatus for AES according to claim 9, wherein AES comprises either one of encryption by AES or decryption by AES.
